(19) United States
(12) Patent Application Publication
(10) Pub. No.: US 2016/0156080 A1
(43) Pub. Date: Jun. 2, 2016

(54) RECEIVING DEVICE FOR RECEIVING AT LEAST ONE ENERGY STORAGE COMPONENT

(71) Applicant: AUDI AG, Ingolstadt (DE)

(72) Inventors: NORBERT ENNING, Denkendorf (DE); BASTIAN GUYOT, Ingolstadt (DE)

(73) Assignee: AUDI AG, Ingolstadt (DE)

(21) Appl. No.: 14/905,590

(22) PCT Filed: Jun. 12, 2014
(86) PCT No.: PCT/EP2014/001600

§ 371 Date: Jan. 15, 2016

(30) Foreign Application Priority Data
Jul. 16, 2013 (DE) 10 2013 011 894.8

(51) Int. Cl. H01M 10/6567; H01M 10/613; H01M 10/625; H01M 2/10

(52) U.S. Cl. CPC H01M 10/6567; H01M 2/1077; H01M 10/613; H01M 10/625; H01M 2220/20

(57) ABSTRACT

A receiving device for receiving at least one energy storage component, includes at least one receiving part that delimits, in at least some sections, a receiving space for receiving the energy storage component, a plurality of receiving compartments being formed in the receiving part for the purpose of receiving at least one energy storage component in an exact fit, and the receiving part being connected to a cooling device arranged directly adjacently thereto for the purpose of cooling the energy storage component that is received, or will be received, in at least one receiving compartment.

The invention relates to a receiving device for receiving sat least one energy storage component, including at least one receiving part which delimits at least regions of a receiving space for receiving the energy storage component.

Corresponding receiving devices for electric energy storages are known and generally serve for receiving or storing energy storage components, such as energy storage cells or electrical or electronic components connected or connectable with the energy storage cells, such as for example charge- or control electronics. For this purpose corresponding receiving devices typically have a receiving part, which delimits a receiving space for receiving the energy storage components.

As is known heat is generated during operation of such energy storage components, which has to be dissipated from the energy storage components and the receiving device that receives the energy storage components, in order to prevent overheating and possible damage resulting from the overheating to the energy storage component, the receiving device and other optional components mounted with the receiving device in a concrete application.

The use of separate cooling devices, which are connected to corresponding receiving devices offer the possibility of a cooling or tempering of corresponding energy storage components or receiving devices. However, a disadvantage of such cooling devices is their required mounting space.

The invention is therefore based on the object to provide an improved receiving device for receiving at least one energy storage component.

The object is solved according to the invention by a receiving device of the aforementioned type, which is characterized in that in the receiving part multiple receiving compartments for receiving at least one energy storage component in an exact fit are formed, wherein the receiving part is connected with a cooling device which directly borders the receiving device for cooling the energy storage component that will be or are received in at least one receiving compartment.

The receiving device according to the invention is characterized on one hand by a particularly configured or constructed receiving part. The receiving part has multiple receiving compartments, whose dimensions are advantageously respectively to one or multiple energy storage component(s) received in the receiving compartments. The respective energy storage components can therefore be inserted with exact fit, optionally with form fit, into the receiving compartments provided therefore. Overall the receiving compartments formed in the receiving par are thus adapted in number, dimension and shape to the number, dimension and shape of the respective energy storage components to be inserted into the receiving compartments.

The respective receiving compartments are typically formed by bridges or webs which in particular extend perpendicular to each other. The respective receiving compartments can typically be open in vertical direction on both sides so that the receiving compartments are typically vertical perforations or openings of the receiving part. However, it is also conceivable that the or defined ones of the receiving compartments are not completely perforated in vertical direction but are rather present in the form of recesses or indentations. The bottom surface of these recesses can be aligned with the bottom surface of the receiving part, which is to be understood as the surface of the receiving part with which it rests on a horizontal support surface. It is also conceivable, however, that the bottom surface of these recesses is elevated relative to the bottom surface of the receiving part.

The receiving part of the receiving device according to the invention is thus typically a frame-like component. The receiving part forms a holding and/or carrier structure for the energy storage components to be received therein, which energy storage components typically are energy storage cells and electric and/or electronic components connected with the energy storage cells, such as a charge or control device which controls the charge and discharge of the energy storage cells.

According to the invention a cooling device also belongs to the receiving device, which is arranged immediately adjacent the receiving part. The cooling device contacts the receiving part thus in sections directly. The contact regions between the cooling device and the receiving part result from the concrete arrangement of the cooling device on the receiving part. It is therefore possible that the energy storage components received in the receiving part as well as of course the receiving part itself can be or are cooled via the cooling device. The describe direct contact enables a good heat exchange and thus an efficient cooling of the energy storage components received in the receiving part and also the receiving part. In exceptional cases thermally conductive elements, such as thermally conductive pastes, glues or the like, can be arranged between the receiving part and the cooling device.

In particular it is possible to integrate a charge or control device, short charging device, which controls the charge and discharge operation of the energy storage cells, into a corresponding receiving compartment and thus into the receiving part. The principle known from the state of the art of a spatially separate arrangement of the corresponding control device is thus overcome. Thus also separate cooling devices for the cooling of corresponding control devices is no longer required because the cooling can be accomplished via the cooling device integrated into the receiving part.

In order to ensure mechanical stability of the receiving part and with this the entire receiving device, it is useful when the receiving part is a metallic die cast part. Correspondingly the further receiving part can preferably be made of materials such as aluminum, magnesium or titanium. A further advantage of such a configuration of the receiving part is that as a result of the high thermal conductivity of the receiving part a high degree of heat transfer from the energy storage components received therein to the receiving part and further to the cooling device connected with the receiving part is possible, which further improves the efficiency of the cooling. Of course it is generally also conceivable to configure the further receiving part not as metallic die cast part but for example as a component made of ceramic or plastic.

In a preferred embodiment of the invention the receiving part forms a side surface of the receiving device. In this embodiment a further receiving part which forms a bottom surface of the receiving device is provided, wherein the cooling device is formed by a coolant channel structure, which includes at least one coolant channel formed in the surface of the further receiving part. The two receiving parts are typically connected with each other wherein the receiving part that forms the side surface of the receiving device is typically placed onto the further receiving part that forms the bottom surface of the receiving device, which further receiving part can thus be referred to as bottom part. The connection of the two receiving parts results in particular from the fact that the cooling device is integrated in the further receiving part or is formed by it. The cooling device is here present in the form of a coolant channel structure which is formed in the surface of the further receiving part and which typically includes multiple coolant cannels.

The further receiving part is thus designed or configured so that a coolant channel structure, which includes one or multiple coolant channels is formed in its surface. The coolant channel structure, which is thus integrated in the receiving part or is formed by the receiving part itself, makes it possible to conduct or circulate a coolant, i.e., for example a liquid or gaseous fluid, along the surface of the receiving part in a concentrated manner. The coolant channel or coolant channels comprised by the coolant channel structure is or are typically arranged so that the coolant can flow or circulate in the manner of a circulation along the surface of the receiving part. The coolant flowing or circulating along the surface of the receiving part can thus be brought as close as possible to an energy storage component(s) to be cooled arranged inside the receiving space, thereby enabling a good heat exchange between the coolant and the energy storage component(s) to the be cooled and thus a high efficiency.

The coolant channels comprised by or delimited by the coolant channel structure can be open or closed, depending on the type of the coolant flowing or circulating through them, i.e., in particular depending on whether it is a gaseous or liquid coolant. In an open configuration the coolant can exit from the coolant channel structure into the receiving space and can thus directly reach the energy storage components to be cooled. The open configuration of the coolant channel structure or the coolant channels is preferably provided when using a gaseous coolant. The gaseous coolant can for example be a correspondingly tempered carbon dioxide. On the other hand in case of a closed configuration, the coolant is spatially separated for the energy storage components to be cooled so that it cannot directly reach the energy storage components to be cooled. The closed configuration of the coolant channel structure or the coolant channels is preferably provided when using a liquid coolant. The liquid coolant can for example be a tempered liquid such as water, a watery solution or oil.

Generally it is conceivable that the entire surface of the further receiving part is provided with a corresponding coolant channel structure. It is also conceivable, however, that only certain regions of the surface of the further receiving part are provided with a corresponding coolant channel structure. The coolant channel structure can also be divided into multiple separate coolant channels, which respectively cover different regions of the surface of the further receiving part. Typically the coolant channels associated with the coolant channel structure communicate directly or indirectly, i.e., in particular via further coolant channels communicating with the latter, with a coolant inlet and a coolant outlet. Hereby it is useful when the coolant channels are arranged so that the coolant flows through the coolant channels in opposite directions at least in sections of the coolant channels. For all variants the coolant channel structure or the associated coolant channels preferably extend meander-shaped.

Preferably the further receiving part thus communicates with at least one coolant inlet and at least one coolant outlet, via which a coolant is introduced into the coolant channel structure, or in particular after passing through the coolant channel structure, can be removed from the coolant channel structure.

The arrangement of the coolant inlet, the coolant outlet and also the coolant channel structure communicating with the coolant outlet and the coolant inlet is selected so that a most homogenous cooling results for all energy storage component to be cooled and to be received or being received in the receiving part. This can for example be achieved in that the coolant inlet and the coolant outlet are arranged at a centered position relative to a longitudinal axis of the further receiving part. In this arrangement coolant enters the coolant channel structure with a low temperature and, after passing through the coolant channel structure, heated coolant exits the coolant channel structure at a centered position with a relatively high temperature. In this way it is possible to compensate the comparatively low cooling efficiency of the coolant, which is heated up after passing through the coolant channel structure, because in its exit region the coolant extends at least in regions adjacent, in particular parallel, to the entry region of the not yet heated coolant.

The coolant channel structure can be formed in the surface of the further receiving part using different technical approaches. On one hand, the coolant channel structure can be formed by shaping the further receiving part, i.e., in particular by a step, which imposes a shape on the further receiving part during production of the receiving part. This variant in particular applies to further receiving parts that are produced via casting processes, such as injection molding processes, i.e., from castable, in particular injectable materials. In this context it is also conceivable to form the further receiving part from an injectable thermoplastic plastic material such as ABS, PE, PP or a castable thermoset plastic material. In both cases it is conceivable that the plastic material is contains reinforcement fibers, such as aramid, glass or carbon fibers. The further receiving part can alternatively also be made from an injectable or castable metal such as for example aluminum or magnesium.

On the other hand, the cooling channel structure can also be formed in the surface of the receiving part by mechanical processing or a material removal, i.e., for example by machining, generally material removing methods, eroding etc. The coolant channel structure can thus be formed subsequent to the actual production of the further receiving part. In this embodiment the selection of materials for the further receiving part is only limited by the fact that the material selected for forming the further receiving part has to be capable of being correspondingly processed. In this embodiment, the further receiving part can also be made of a plastic material or a metal.

The geometric shape, i.e., in particular the cross section of the coolant channels, is generally freely selectable. For example the coolant channels can have a semicircular, V-shaped, U-shaped cross section. The cross section of the coolant channels can change or can differ in sections along their longitudinal extent.

The geometric shape of the further receiving part can generally be freely selected or is selected in dependence on a particular application or installation situation for the entire receiving device, for example an installation situation in a motor vehicle. However, in a useful embodiment of the further receiving part, the further receiving part is trough or tub-shaped. The further receiving part has thus preferably a base area with borders, which protrude from the base area at an angle, in particular a right angle. The shape of the base area can again be freely selected, i.e., in particular with regard to the type of application or installation situation of the entire receiving device. The base area, and in particular also the height of the borders protruding from the base area, define the volume of the receiving space delimited by the further receiving part. The further receiving part therefore also constitutes a part for of the receiving space provided by the receiving device for the energy storage component(s). The height of the borders of the further receiving part can be understood as a measure for the proportion of the receiving space delimited by the further receiving part. Overall, the receiving space of the receiving device according to the invention is thus defined by the respective receiving space proportions of the receiving parts of the receiving device.

As mentioned the coolant channel structure or the coolant channels associated therewith can be configured closed. This can for example be realized in that the coolant channel structure is covered by at least one plate-shaped cover element. The plate-shaped cover element thus seals or covers the coolant channels towards the top in relation to the surface of the further receiving part. The dimensions and the shape of the plate-shaped cover element are typically adapted to the dimensions and the shape of the further receiving part, i.e., in particular to the dimensions and the shape of the base area of the further receiving part, so that the cover element can be inserted into the further receiving part so as to cover at least a portion of the coolant channel structure. Hereby in particular the region of the coolant channel structure is covered in which the energy storage components will be or are arranged. The plate-shaped cover element can for example be a plan plate made of a plastic material or metal. The configuration using metal is preferred because metal has a comparatively better thermal conductivity, which facilitates heat transfer from the energy storage components to be cooled to the cover element and the coolant flowing in the coolant channel structure.

The at least one coolant inlet and the at least one coolant outlet are typically formed in the plate-shaped cover element. The at least one coolant inlet and also the at least one coolant outlet are for example formed as connection ports, which are in particular configured integral with the plate-shaped cover element.

The plate shaped cover element is advantageously connected with the surface of the further receiving part via at least one connection point. Of course also a partial of full-surface connection of the cover element with the surface of the further receiving part is possible. The connection, i.e., in particular the formation of the connecting points, can be accomplished via gluing or welding. Conceivable are also mechanical connections, such as flanging, riveting, screwing, in order to generate a connection between the cover element and the surface of the further receiving element.

In an advantageous refinement of the invention the coolant inlet and the coolant outlet are arranged in a separate region of the plate-shaped cover element, which is spatially separated from the region that delimits the receiving space. This ensures that the coolant inlet and the coolant outlet are arranged in a region of the plate-shaped cover element, which is regularly located spaced apart from the regions of the receiving part that delimit the receiving space, so that the receiving space is unobstructed also when the receiving space is covered by a lid or closure element and therefore well accessible.

As mentioned, the further receiving part can for example be made of a plastic material or metal. Both materials or material groups are characterized by specific advantages. For example a plastic material offers a relatively high thermal and electric insulation. On the other hand, a metal offers for example relatively high mechanical stability. The actual material is therefore selected depending on the demands placed on the receiving device. Hereby in particular the installation situation of the receiving device in a greater constructive context is to be taken into account.

In order to fully close or seal the receiving space delimited by the further receiving part, and optionally by the further receiving part, a cover or closure part can be provided via which the receiving space can be closed at least toward an open side. The correct arrangement or connection of the closure part with the receiving part(s) thus results in a sealing and protection of the energy storage components received in the receiving space against mechanical and corrosive influences.

Further advantages, features and details of the invention will become apparent from the exemplary embodiments described below and from the drawings. It is shown in:

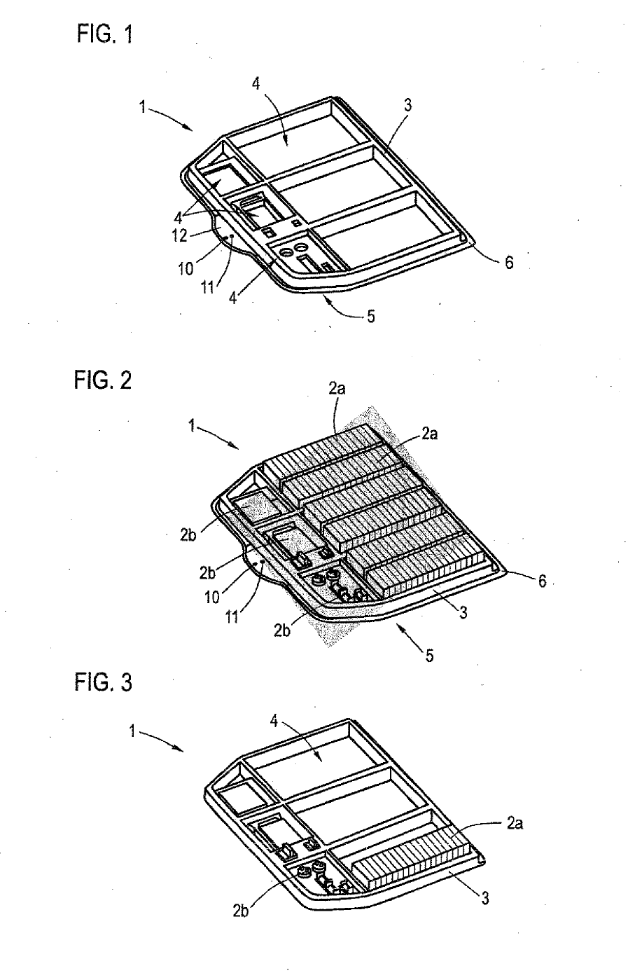

FIGS. 1, 2 a receiving device according to an exemplary embodiment of the invention;

FIG. 3 an individual view of the receiving part shown in FIGS. 1, 2;

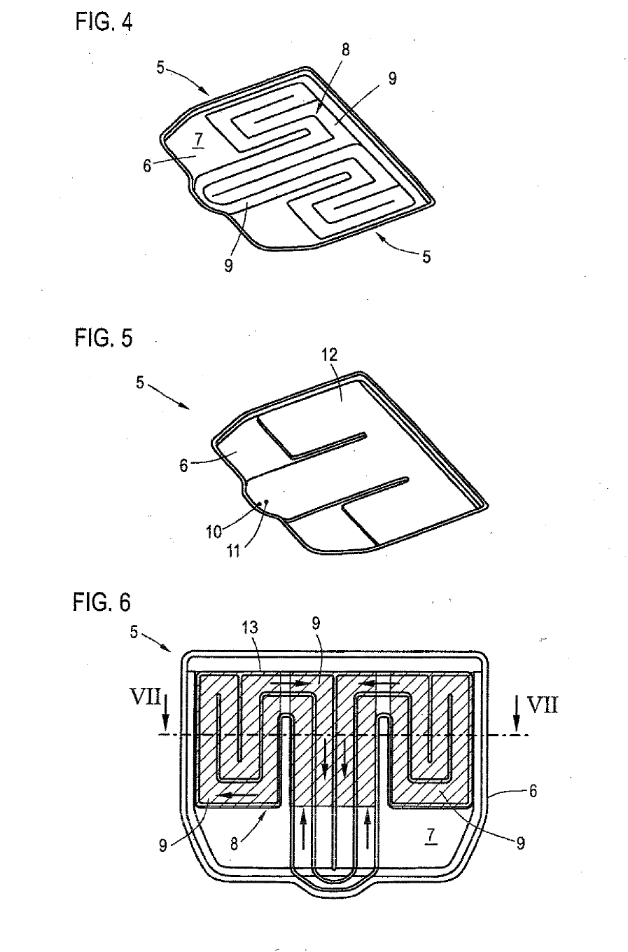

FIGS. 4, 5 in each case a further receiving part of a receiving device according to an exemplary embodiment of the invention;

FIG. 6 a top view onto the further receiving part shown in FIG. 4;

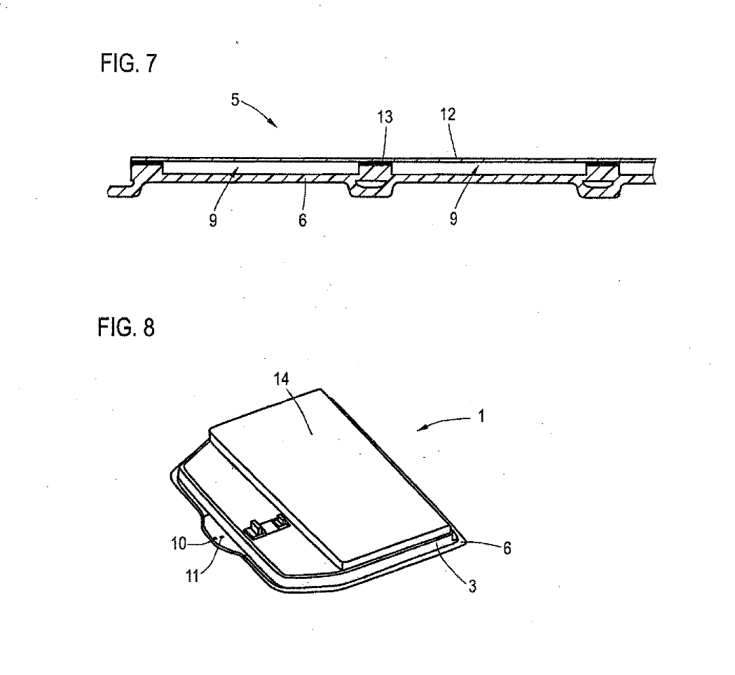

FIG. 7 a section along the sectional lines VI-VI shown in FIG. 6; and

FIG. 8 a receiving device according to a further exemplary embodiment of the invention.

FIG. 1 shows a receiving device 1 according to an exemplary embodiment of the invention. The receiving device 1 serves for receiving different energy storage components 2 (see FIG. 2). The energy storage components 2 are in particular energy storage cells 2a and electronic components 2b, such as a charge or control electronics, which controls the charge and discharge operation of the energy storage cells 2a. All energy storage components 2 form an energy storage or a battery. The receiving device 1 can be understood as housing for the energy storage. The receiving device 1 is typically installed in a motor vehicle. The energy storage components 2 received in the receiving device 1, i.e., in particular the energy storage formed by the energy storage components, serves for supplying high-voltage and/or low-voltage loads of the motor vehicle with electric energy.

The receiving device 1 includes a frame-like receiving part 3. The receiving part 3 is a mechanically highly stable metallic die cast part, i.e., for example an aluminum die cast part. Due to the frame-like shape of the receiving part 3 the latter can be understood as carrier structure for the energy storage components to be received therein (see FIGS. 2, 3). The frame-like shape of the receiving part 3 results from corresponding receiving compartments 4 formed in the receiving part 3. The receiving compartments 4, which are formed respectively as vertical perforations of the horizontally extending base area of the receiving part 3, respectively serve for the reception in an exact fit, optionally also even form fitting reception, of one or multiple defined energy storage components 2, i.e., in particular at least one energy storage cell 2a and/or at least one electronic component 2b. Thus the dimension of the respective receiving compartments 4 are adapted to the dimensions of the respective energy storage components 2 to be received therein. The relatively larger receiving compartments 4, which are situated on the right hand side of a center divisional in FIG. 1 serve for receiving energy storage cells 2a, the relatively smaller receiving compartments 4 which are situated on the left hand side of the center divisional, serve for receiving electronic components 2b.

The arrangement of corresponding energy storage components 2 in the receiving compartments 4, and thus the receiving part 3 and with this the receiving device 1 with mounted corresponding energy storage components 2, is shown in FIG. 2. FIG. 2 further illustrates that the arrangement of the receiving compartments 4 is selected so that all energy storage components 2 to be arranged in the receiving compartments 4, and which require cooling during operation, rest on the bottom side directly on a cooling device 5. The receiving part 3 is thus directly connected with a cooling device 5, which directly borders the receiving part 3 for cooling the energy storage components 2 that will be or are received in the receiving compartments 4.

The cooling device 5 is integrated in a further receiving part 6 shown in FIGS. 4-7. As can be seen, the further receiving part 6 forms a bottom surface of the receiving device 1, whereas the receiving part 3 forms side surfaces of the receiving device 1.

The further receiving part 6 has a trough-shape with a base area 7 and borders perpendicularly protruding from the base area 7. In this way a part of the receiving space of the receiving device 1 for receiving corresponding energy storage components 2 is also formed in the further receiving part 6. The further receiving part 6 therefore delimits sections of the receiving space of the receiving device 1. The further receiving part 6 is an injection-molded component made from a thermoplastic plastic material such as for example PP, which contains reinforcement fibers, in particular glass fibers.

As can be seen in particular in FIGS. 4 and 6, a coolant channel structure 8 is formed in the surface of the further receiving part 6, i.e., in particular in the surface of the base area 7 of the further receiving part 6. The coolant channel structure 8 includes multiple coolant channels 9, which are formed by groove or gulley like longitudinal indentations of the surface and extend meander-like. The coolant channel structure 8 or the coolant channels 9 can be formed during production of the further receiving part 6. It is also conceivable to introduce the coolant channel structure 8 or the coolant channels 9 by material removing processes into the surface of the further receiving part 6.

As discussed in the following, a coolant, i.e., for example a cooling gas or a cooling liquid, in particular water or mixtures of water and other liquids such as glycol, flows through the coolant channel structure 8 formed in the surface of the base area 7 of the further receiving part 6. The coolant is introduced via a coolant inlet 10 arranged in a region of a plate-shaped cover element 12, which extends from a center section of the base area 7. In the region of the coolant inlet 10 a coolant outlet 11 is further provided via which the coolant, which has flowed through the coolant channel structure 8, can exit from the coolant channel structure 8 and with this from the further receiving part 6. The coolant inlet 10 and the coolant outlet 11 are respectively connection sockets, which can be integrally formed with the plate-shaped cover element 12. Overall therefore a coolant can flow through the coolant channel structure 6 in the manner of a circulation, thus ensuring a sufficient cooling of the energy storage components 2, which are received in the receiving device 1 during operation and with this a sufficient cooling of the energy storage formed by the energy storage components 2.

The flow of the coolant through the coolant channels 9 or through the coolant channel structure 8 is illustrated in FIG. 6. The coolant entering the coolant channel structure 8 through the coolant inlet 10 is divided into two separate coolant channels 9. The flow of the coolant inside the coolant channels 7 or the coolant channel structure 8 in different directions is indicated by respective arrows.

The arrangement of the coolant inlet 10 and the coolant outlet 11 and the symmetric arrangement and the extension of the coolant channels 9 are selected so as to ensure a homogenous cooling of the energy storage components 2 to be cooled. In FIG. 6 exemplary arrangement regions of energy storage cells 2a to be received in the receiving device 1 are indicated with hatched surfaces. As a result of the flow of the coolant in opposite directions through the coolant channel structure 8, indicated by the arrows, the energy storage cells 2a are therefore cooled homogenously. The energy storage cells 2a arranged in the region of the centered hatched surface in FIG. 6 are cooled with equal parts of coolant having the relatively low entry temperature and coolant having the relatively warm exit temperature. For the energy storage cells 2a arranged in the region of the upper and lower hatched surface, the temperature difference of the coolant streams which flow in opposite directions is reduced so that on average a most homogenous cooling of all energy storage cells 2a can be realized.

In order to prevent the coolant flowing in the coolant channels 9, and with this in the coolant channel structure 8, from exiting within the receiving part 3 from the coolant channels 9 or the coolant channel structure 8 and thus contact the energy storage components 2 to be cooled, the cooling channels 9 are covered on the top via the already mentioned plate-shaped cover element 12 in form of a metallic plate made of a thermally well conductive metal, such as aluminum (see FIG. 2, 7). The cover element 12 is for example connected fixedly with the base area 7 of the receiving part 3 via an adhesive connection (see FIG. 7, adhesive regions 13). FIGS. 1, 2 show that a heat exchange from the energy storage components 2 received in the receiving part 3 to the coolant flowing in the coolant channel structure 8 or the coolant channels 7 of the coolant channel structure 8 is possible via the cover element 12.

FIG. 8 shows that the arrangement of the closure part 14 on the receiving device 1 shown in FIG. 2 enables a full coverage and with this enclosure of the energy storage components 2 arranged in the receiving space or the receiving compartments 4. The energy storage components 2, or the energy storage formed by these energy storage components, received in the receiving device 1 is thus completely sealed and protected against the outside, i.e., against external in particular mechanical and corrosive influences.

The connection of the receiving part 3, the further receiving part 6 and the closure part 14 is accomplished via gluing so that a sufficient, in particular immersion-proof, sealing of the energy storage components 2 situated in the receiving space formed in the receiving device 1 is given. The gluing is accomplished with a hot melt adhesive, which can be solubilized by applying heat, for example by means of a heated wire. This allows service and repair work to be conducted for example on the energy storage components 2.

Only in the region of the electric connections, i.e., in particular electronic components 2b which represent a high-voltage and a low-voltage connection shown in FIG. 8, a recess is provided inside the closure part 14 so that a proper electric contacting or connection of the energy storage components 2 or the energy storage formed by them with a corresponding application, i.e., in particular a motor vehicle or corresponding electric loads of the motor vehicle is possible.

FIG. 8 further shows that the coolant inlet 10, and the coolant outlet 11 are arranged in a separate region of the plate-shaped cover element 12, which is spatially separated from the regions that delimit the receiving space. The coolant inlet 10 and the coolant outlet 11 are therefore exposed so as to be always well accessible.

FIGS. 1-4 and 8 show that the receiving device 1 can be assembled from multiple components, i.e., the receiving part 3, the further receiving part 6 and the closure part 14, in a modular manner.

Important advantages of the receiving device 1 shown in the Figs. are that due to their mechanical stability they can also be arranged or installed in regions of a motor vehicle that are subject to stress, for example in the region of the underbody. The coolant channel structure 8 directly integrated in the receiving part 3 ensures a sufficient cooling of all energy storage components 2, in particular also corresponding electronic components 2b. All electric or electronic connections and also connections for the supply and discharge of the coolant are integrated in the receiving device 1 in a space-efficient manner and are well accessible.

1.-14. (canceled)

15. A receiving device for receiving at least one energy storage component comprising:
at least one receiving part which delimits at least regions of a receiving space for receiving the at least one energy storage component, said receiving part having multiple receiving compartments formed therein for receiving the at least one energy storage component in an exact fit, and
a cooling device for cooling the energy storage component received in the at least one receiving compartment, said cooling device being arranged directly adjacent the receiving part, said receiving part being connected with the cooling device.

16. The receiving device of claim 15, wherein dimensions of the respective ones of the receiving compartments are adapted to dimensions of the at least one energy storage component.

17. The receiving device according to claim 15, wherein the receiving part is a metallic die cast part.

18. The receiving device of claim 15, further comprising a further receiving part, wherein the receiving part forms a side surface of the receiving device and the further receiving part forms a bottom surface of the receiving device, wherein the cooling device is formed by a coolant channel structure, which is formed in a surface of the further receiving part and comprises at least one coolant channel.

19. The receiving device of claim 18, further comprising at least one coolant inlet and a coolant outlet, said at least one coolant inlet and said coolant outlet communicating with the coolant channel structure.

20. The receiving device of claim 18, wherein the coolant channel structure is formed by shaping the further receiving device and/or a material removal from the further receiving device.

21. The receiving device of claim 18, wherein the further receiving part has a trough-shape.

22. The receiving device of claim 21, wherein the trough-shape is formed by borders which protrude from a base area of the further receiving pat at an angle.

23. The receiving device of claim 18, further comprising at least one plate-shaped a cover element covering the coolant channel structure.

24. The receiving device of claim 23, wherein the cover element is connected with the surface of the further receiving part via at least one connection point.

25. The receiving device of claim 19, wherein the coolant inlet and the coolant outlet are arranged in a region of the plate-shaped cover element which is spatially separated from regions of the cover element that delimit the receiving space.

26. The receiving device of claim 18, wherein the coolant channel structure extends meander-shaped at least in sections along the surface of the further receiving part.

27. The receiving device of claim 18, wherein the further receiving part is made of a plastic material or a metal.

28. The receiving device of claim 15, further comprising a closure part constructed for closing the receiving space toward at least one open side.
